(19) United States
(12) Patent Application Publication
(10) Pub. No.: US 2010/0025391 A1
(43) Pub. Date: Feb. 4, 2010

(54) COMPOSITE INDUCTIVE HEATING ASSEMBLY AND METHOD OF HEATING AND MANUFACTURE

(75) Inventors: John Palombini, Burlington, VT (US); Kyle B. Clark, Underhill, VT (US); Stefan von Buren, Colchester, VT (US)

Correspondence Address: RISSMAN HENDRICKS & OLIVERIO, LLP, 100 Cambridge Street, Suite 2101, BOSTON, MA, 02114, US

(73) Assignee: iTherm Technologies, L.P., Merrimack, NH (US)

(21) Appl. No.: 12/183,797

(22) Filed: Jul. 31, 2008

(51) Int. Cl. H05B 6/36

(52) U.S. Cl. 219/672

(57) ABSTRACT

A composite inductive heating assembly capable of providing in various embodiments, one or more of a variable or higher power density, tighter temperature control, reduced power consumption, longer operating life, and lower manufacturing costs, particularly in a compact design. A composite inductive heating assembly includes an inner layer of dielectric material, a multi-turn coil disposed over the inner layer, and an outer self-supporting body of moldable flux concentrator material rendering the inner layer, coil and flux concentrator into a self-supporting assembly. Select embodiments of the composite heating assembly include a nozzle heater and a manifold heater. A method of manufacturing the composite heater in a mold, with application of heat and pressure, is described.

### FIELD OF THE INVENTION

This invention relates to a composite inductive heating assembly, capable of providing, in various embodiments, a variable or higher power density, tighter temperature control, reduced power consumption, longer operating life, and/or lower manufacturing costs.

### BACKGROUND OF THE INVENTION

Injection molding is one of many large scale industrial applications that require reliable localized heating elements of compact design. In the injection molding process, plastic melt is transmitted from an extruder to an injection mold cavity via a hot runner manifold having an elongated cylindrical passageway (melt channel) through which the molten plastic flows, enroute to the mold cavity. The manifold is heated to maintain the temperature and otherwise prevent the molten plastic from solidifying on the inner wall of the channel. After exiting the heated manifold, and just prior to entering a cold mold cavity in which the plastic solidifies and forms a molded article, the plastic travels through a nozzle which is heated to prevent the adjacent cold mold cavity plate from cooling and prematurely solidifying the plastic melt in the nozzle before it reaches the mold cavity.

In a traditional nozzle heating assembly, resistive heater bands engage the outer circumference of each nozzle. Heat resistively generated in the heater bands must then be thermally conducted to the nozzle, requiring direct physical contact between the heater assembly and nozzle for optimum thermal conduction. Maintaining such close physical contact between these separate components is difficult, mandating tight machining tolerances (which increase the component costs) and careful selection of thermal expansion coefficients (which limits the choice of materials).

One proposed solution is to machine a grove in the nozzle, inlay the resistive heating element, and then hammer (or solder) on a bronze cap effectively making the heater a part of the nozzle. A problem arises in that these resistive heating elements commonly burnout by overheating. Replacement of the heater bands is a time consuming and expensive process, both in terms of down (lost) production time and labor/material costs, and any design which integrates the nozzle and heater band (e.g. embedding and capping the heater band in a groove) only adds to the cost/complexity of replacing a burned out heater.

Another approach is to provide a slide-on resistive heating element, thus making assembly and disassembly quicker and more convenient. However, these slide-on nozzle heaters require very high mechanical tolerances, i.e. a close fit between the outer nozzle diameter and inner sleeve diameter, which makes them costly to manufacture. Also, there will inherently be some air gap between the sleeve and nozzle, which substantially reduces the effective thermal conduction and overall efficiency of heat transfer. Still further, because a resistive heating coil must be heated to a temperature higher than the desired nozzle temperature, the reduced thermal conduction of an air gap only increases the incidence of burnout of the heater coil.

Another problem which must be addressed is the varying thermal profile along the length of the nozzle, due to varying contact with and/or temperatures of adjacent mold components. In certain applications the majority (90%+) of the thermal losses are through the nozzle skirt at the rear of the nozzle and the gate pad at the tip of the nozzle. These variations in thermal losses produce temperature gradients in the nozzle which further complicates the ability to provide a uniform temperature of the plastic melt flowing through the nozzle channel. As a result of these temperature gradients, the nozzle areas with low thermal losses are often overheated, which can lead to degradation of the plastic melt, as well as reduced heating efficiency (excessive power consumption). Limitations on power density of a given heating element may preclude applying the majority of the power at each end (the regions of highest thermal losses).

Thus, there is an ongoing need for a heating assembly and method which can provide one or more of a variable or higher power density, tighter temperature control, reduced power consumption, longer operating life, and/or lower manufacturing costs, particularly in a heating assembly of compact design.

### SUMMARY OF THE INVENTION

The present invention is directed to a composite inductive heating assembly, a method of inductive heating, and a method of manufacturing a composite inductive heating assembly.

In one embodiment, a composite inductive heating assembly is provided which includes:
an inner layer of dielectric material;
a multi-turn conductive heater coil disposed over the inner layer;
an outer self-supporting body of moldable flux concentrator material rendering the inner layer, coil and flux concentrator into a self-supporting composite assembly.

In one embodiment, the heating assembly is a hollow tubular article. This embodiment may function as a nozzle heater, wherein the heating assembly is positionable over an electrically conductive and preferably ferromagnetic (hereinafter electrically conductive and/or ferromagnetic) article to be inductively heated. The inner layer may include standoff elements for spacing the inner layer apart from the article.

The composite assembly may be of compact design, for example having a radial thickness of from 1.5 to 2 mm. This composite design is enabled by providing an inner dielectric layer and heater coil which are each relatively thin and flexible, and wherein the outer self-supporting body of moldable flux concentrator material provides the structural integrity for the entire assembly. For example, the coil may be a thin and flexible low current coil having a maximum rating of 10 amps RMS.

The flux concentrator material may be selected from the group consisting of polymer materials capable of maintaining structural integrity at the operating temperature of the flux concentrator body, and including a ferromagnetic additive. The ferromagnetic additive may be selected from the group consisting of iron, cobalt, and nickel, and alloys and oxides thereof. In one example, the flux concentrator material comprises of a thermoset polymer and iron oxide particles. The outer body may be thermoformed. The outer body may be thermally insulative, to reduce thermal conduction to the surrounding environment.

In one embodiment, the coil has turns of varying pitch. The coil may comprise one or more spaced apart coil groups, each coil group comprising of plurality of a more tightly wound coil turns for delivering a higher power density than the areas between the groups. For example, the assembly may comprise a nozzle heater having an axial length wherein the coil has varying pitch along the axial length for delivering a higher power density along select portions of the nozzle, e.g. at opposing ends of the heater length where thermal losses are higher.

Optionally, a dielectric layer may be provided between the coil and outer body to substantially prevent the flux concentrator material from entering the area between the coil turns.

In another embodiment, a method is provided of inductively heating an electrically conductive and/or ferromagnetic article. The method includes the steps of:
positioning a composite conductive heating assembly around the article, the assembly comprising an inner layer of dielectric material adjacent the article, a multi-turn inductive heater coil disposed over the inner body for inducing a magnetic flux within the article, and an outer self-supporting body of moldable flux concentrator material rendering the inner layer, coil and flux concentrator into a self-supporting composite assembly, and supplying a signal to the coil to generate a magnetic flux in the article.

In one method, the composite heating assembly may be positioned within a bore of an outer electrically conductive and/or ferromagnetic body. The outer flux concentrator body substantially constrains the magnetic flux to lie within the inner article to be heated so as to limit inductive heating of the outer article. The outer article may be cool, and the flux concentrator material may be thermally insulated to limit thermal conductive of heat from the coil to the outer article.

In another embodiment of the invention, a method of making a composite inductive heating assembly is provided, including:
providing an inner layer of dielectric material;
providing a multi-turn coil over the inner layer;
applying a moldable flux concentrator material over the coil and inner layer and applying pressure to transform the flux concentrator material into a self-supporting substantially non-deformable state, thereby rendering the inner layer, coil and flux concentrator into a self-supporting composite assembly.

Heat and pressure may be applied to form the assembly. The assembly may be formed by disposing the inner dielectric layer and coil over a mold core and forming the heater assembly in an outer mold assembly.

These and other embodiments are an advantage of the present invention will be illustrated in the following detailed description.

### BRIEF DESCRIPTION OF THE DRAWINGS

FIG. 1 is a perspective view of one embodiment of a composite inductive heating assembly according to the present invention, wherein the assembly comprises a nozzle heater and is shown concentrically disposed over a nozzle;

FIG. 2 is a cross-sectional view taken along section lines 2-2 of FIG. 1, and FIG. 2a is an exploded view of the assembly layers;

FIG. 3 is a cross-sectional view of the heater assembly and nozzle of FIG. 1 disposed in a plastic hot runner system of an injection molding machine, and FIGS. 3a and 3b are enlarged detail views (taken from FIG. 3) showing the rear (skirt) and front (tip) end of the nozzle assembly to illustrate the areas of greatest heat loss;

FIG. 4 is an enlarged sectional view of the tip portion of the heater assembly and nozzle in the mold (as shown in FIG. 3);

FIG. 5 is a graph of temperature vs. radial position going from the center of the melt channel outwardly to the mold assembly, showing a radial temperature profile for the inductive heating assembly of FIG. 4;

FIG. 6 is an enlarged sectional view of a comparative (hypothetical) resistive nozzle heater, similar to FIG. 4;

FIG. 7 is a radial temperature profile of the comparative resistive heater of FIG. 6;

FIG. 8 is a radial cross-sectional view of an alternative composite heating assembly of the present invention, disposed over a nozzle, and including axial standoffs to maintain a constant (air) gap between the nozzle and inductive heating assembly;

FIG. 9 is an axial cross-sectional view of an alternative inductive heating assembly disposed in a mold assembly similar to that of FIG. 3; in this embodiment a relatively high aspect ratio nozzle heater is shown having a central region in contact with the adjacent mold assembly;

FIG. 10 is an exploded parts view of a manufacturing assembly, and FIGS. 10a-10f are schematic views of a process utilizing this assembly, for making the composite inductive heating assembly of FIG. 1-4 according to one embodiment;

FIG. 10g is an exploded detail and sectional view of a portion of the resulting flux concentrator body of the molded assembly;

FIG. 11 is a perspective view of a traditionally heated manifold system (prior art) having an embedded resistive heater;

FIG. 12 is a sectional view taken along section lines 12-12 of FIG. 11, showing the embedded resistive heater and manifold thickness;

FIG. 13 is a front planar view of a manifold similar to that shown in FIG. 11, but heated by a planar composite inductive heating assembly according to another embodiment of the invention;

FIG. 14 is a perspective and partial cutaway view of the inductive heating assembly and manifold of FIG. 13 showing the various layers of the heating assembly; and

FIG. 15 is a sectional view taken along section lines 15-15 of FIG. 13 showing the layers of the inductive heating assembly and reduced manifold thickness.

### DETAILED DESCRIPTION

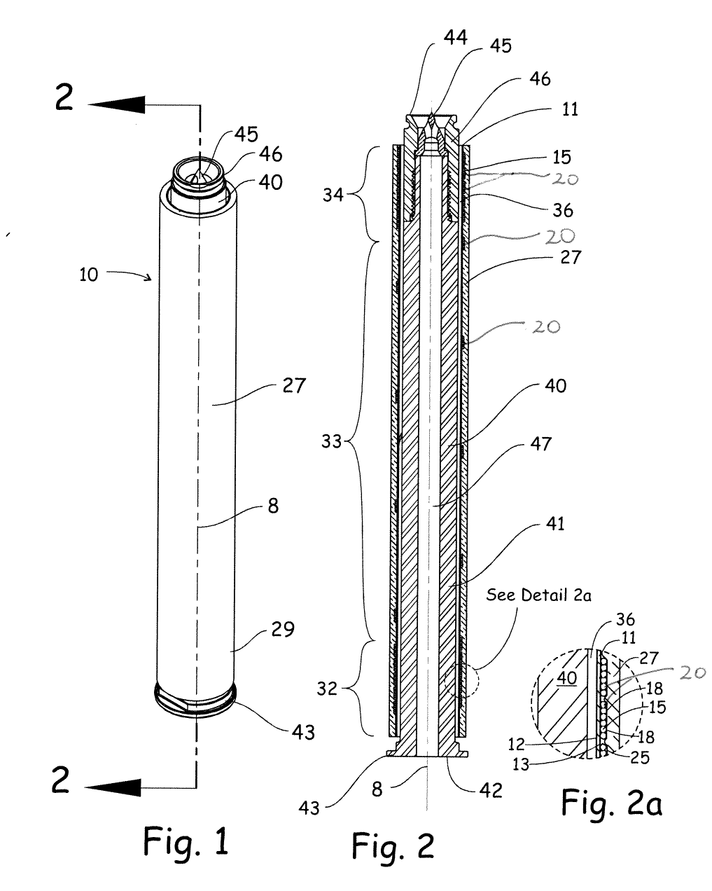

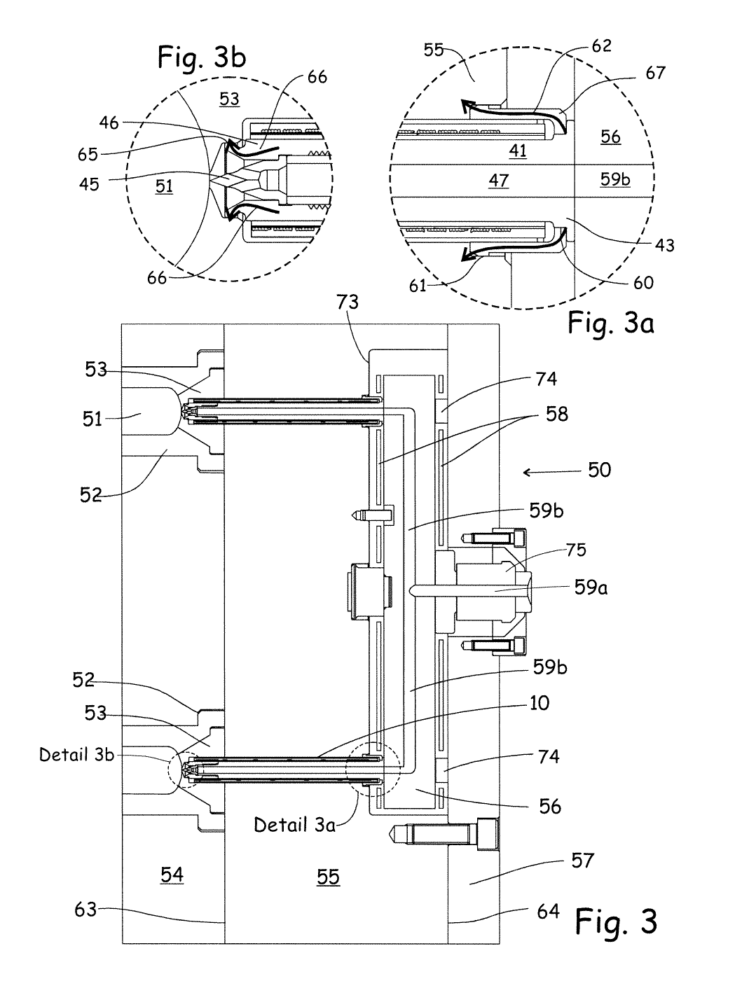

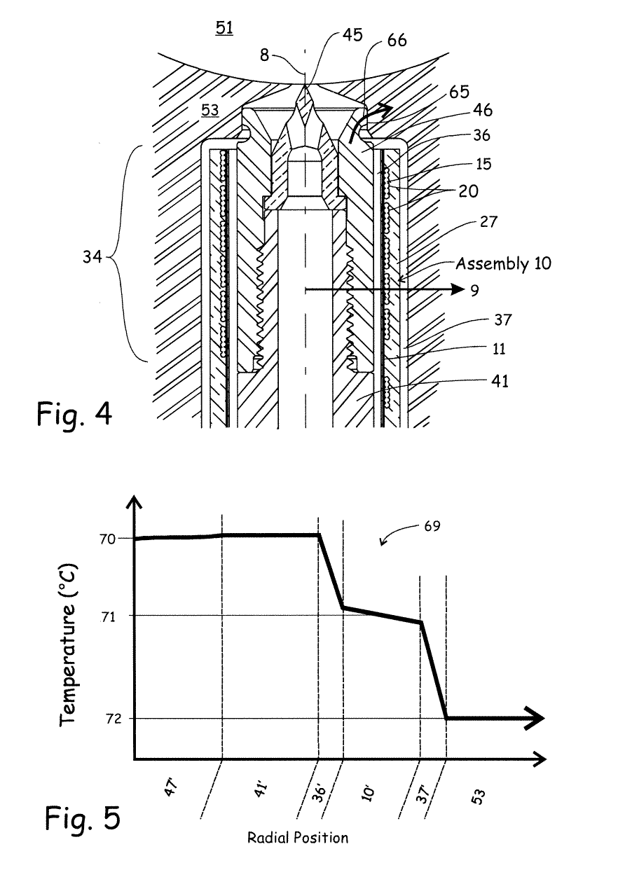

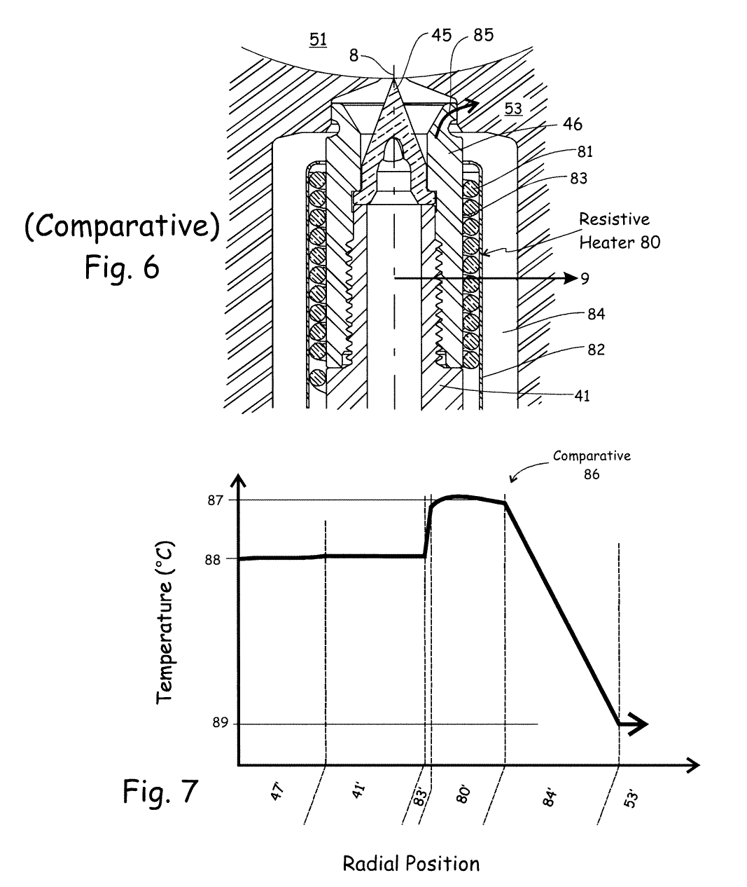

One embodiment of the invention will now be described, wherein the composite inductive heating assembly is configured to function as a nozzle heater. FIGS. 1-2 show a cylindrical (hollow tubular) composite nozzle heater disposed over a cylindrical (hollow tubular) nozzle. FIG. 3 is a cross sectional view of the composite heater and nozzle in a plastic hot runner system of an injection molding machine, including two detailed views (FIGS. 3a-3b) illustrating schematically the primary sources of thermal losses at the front and rear ends of the nozzle assembly. FIG. 4 is an enlarged cross-sectional view of the tip zone of the nozzle, heater and surrounding mold and FIG. 5 is a radial temperature profile illustrating the benefits of this one embodiment of the invention. FIGS. 6-7 illustrate a comparative resistive heater assembly and contrasting radial temperature profile.

FIG. 1 is a perspective view of the inductive nozzle heater assembly 10 disposed over a nozzle 40. In this environment, the nozzle tends to be relatively long and thin, having a high aspect ratio of axial length to outer diameter. An axial center line 8 runs through the center of the inner nozzle 40 and outer heater assembly 10, the assembly 10 being concentrically disposed over the nozzle 40. At the rear (skirt) end of the nozzle, a radial extending base (flange) 43 is exposed outside the heating assembly 10, and at the opposing tip end, a central nozzle tip 45 and nozzle tip retainer 46 extend axially from the heating assembly 10. In this view, only the outer surface 29 of the outer cylindrical body 27 of the heater assembly is visible.

FIG. 2 is an axial cross-sectional view taken along section lines 2-2 in FIG. 1. The nozzle 40 is centrally located and includes, from the rear skirt end 42 to the opposing tip end 44, a radially extending flange 43, an elongated cylindrical nozzle housing 41, and at the opposite end a separate nozzle tip retainer 46 threadably engaged with nozzle housing 41; a nozzle tip 45 having a rear flange is held between the nozzle housing 41 and the retainer 46.

The inductive heating assembly 10 is concentrically disposed over the nozzle 40, and includes, moving radially outwardly, an inner dielectric layer 11, a coil 15, and an outer body of flux concentrator material 27. Optionally (as shown in FIG. 2a) an outer dielectric layer 25 may be disposed between the coil 15 and outer body 27 to keep the outer body 27 outside of the area between the coil turns. In accordance with the present invention, the outer body 27 is a self-supporting body of moldable flux concentrator material which renders the inner dielectric layer 11, coil 15 and flux concentrator into a self-supporting composite assembly 10. One method of forming such an assembly is described in later sections of this application.

The inner dielectric layer 11 has an inner surface 12 which can be disposed immediately adjacent or spaced apart from (by an inner air gap 36) the outer surface of the nozzle 40. The coil 15 has multiple turns and is positioned over the outer surface 13 of the inner layer 11. Electrical leads (not shown) extend from the coil 15 and are connected to a power source and/or controller (e.g. microprocessor based controller) for supplying an alternating current through the coil which generates a magnetic flux in the electrically conductive and/or ferromagnetic (e.g. steel) nozzle 40, thereby inducing an eddy current and inductive heating of the nozzle 40. In this embodiment, the coil has multiple turns of varying pitch along the axial length of the nozzle. More specifically, the coil turns form groups 20 each having relatively closely spaced turns within a group, and spaced areas 19 between the groups 20. This coil grouping is useful in the present embodiment for delivering a higher power density in the areas having higher thermal losses, namely at opposite ends of the nozzle (shown in FIG. 2 as base zone 32 and tip zone 34; in contrast, the middle zone 33 has relatively fewer coil turns). This higher number of coil turns at each end enables generation of a greater magnetic flux in the base and tip zones 32 and 34 of the nozzle, to compensate for the higher thermal losses in those areas. The base and tip nozzle areas are losing heat to adjacent cold portions of the injection mold assembly. In contrast, in the middle zone, there is relatively less conductive heat transfer loss from the nozzle to the mold. Thus, in order to achieve a relatively uniform temperature of the nozzle 40 along its axial length, which produces, in turn, a relatively uniform temperature profile of the polymer melt flowing through the central melt channel 47 of the nozzle, the present heating assembly includes coil groupings in a relatively compact design which enable delivery of sufficient power at each end of the nozzle to overcome the substantial thermal losses from the hot nozzle to the cold mold assembly.

As shown in FIG. 2, the outer body of flux concentrator material 27 has an inner surface 28 (here comprising the inner diameter) which is adjacent to the outer surface 18 of coil 15. The opposing outer surface 29 (here the outer diameter) of outer body 27 will be disposed adjacent a bore in the injection mold assembly 50, as described below. The flux concentrator body 27 serves two purposes, namely it provides structural support to the assembly 10 and it also concentrates the magnetic flux in the nozzle 40 so as to enhance inductive heating of the electrically conductive and/or ferromagnetic (steel) nozzle, as opposed to the electrically conductive and/or ferromagnetic (steel) outer mold assembly 50 (see FIG. 3). The flux concentrator may also be thermally insulative, to reduce conduction of heat from the nozzle 40 and coil 15 to the exterior mold assembly 50. Similarly, the inner dielectric layer 11 may be thermally insultative, to retard thermal conduction of heat from the nozzle 40 to one or more of the coil 15, flux concentrator 27 and exterior mold assembly 50.

FIG. 3 shows the nozzle 40 and inductive nozzle heating assembly 10 (of FIGS. 1-2) positioned in a plastic hot runner system of an injection mold 50. Detailed FIGS. 3a and 3b are enlarged views of the rear (skirt) and front (tip) ends of the nozzle/assembly illustrating the thermal losses (heat flux paths).

The injection molding system 50 includes, from left to right, a cavity plate 54, a manifold plate 55, a manifold 56, and a manifold backing plate 57. The cavity plate 54 includes a plurality of cavity inserts 52 each forming a mold cavity 51, and a gate insert 53 forming the lower end of the cavity 51. The cavity plate 54 abuts the manifold plate 55 at interface 63. The manifold plate 55 has multiple bores for holding multiple nozzles and their associated heater assemblies 40/10. The rear manifold backing plate 57 secures the heated manifold 56 to the rear 73 of the manifold plate 55, via spacers 74. The manifold 56 has a plurality of manifold channels 59b for delivering plastic melt to each of the nozzle heater assemblies 40/10. The plastic melt is fed through a central channel 59a in a sprue bushing 75 (extending through the manifold backing plate 57), the melt being supplied through the channel 59a by an extruder (not shown). The manifold 56 is heated by manifold heaters 58 for the purpose of maintaining the temperature of the melt flow in the channels 59b. The manifold plate 55 is relatively cool compared to the manifold 56; for this reason, a nozzle heater 10 is provided around each nozzle 40 to maintain the temperature of the polymer melt in the nozzle channel 47 for delivery to the cavity 51. The cavity plate 54, cavity insert 52 and the gate insert 53 are all relatively cool compared to the heated nozzle 40.

FIG. 3a shows a major source of heat loss at the rear end of the nozzle. A tubular nozzle skirt 67 is concentrically disposed about the rear end of the nozzle 41, and abuts the base (flange) 43 of the heated nozzle. The skirt 67 is a separate component, typically made of a high strength, low thermal conductivity alloy such as titanium or stainless steel. It surrounds the rear end of the nozzle and functions to: 1) enable centering of the nozzle in the manifold plate; 2) resist the compressive forces between the manifold plate 55 and the manifold 56; and 3) reduce conductive heat loss from the hot nozzle to the cool manifold plate 55. However, typically there will still be significant thermal losses through the skirt 67 from the hot contact area 60 at the nozzle base to the opposing cold contact area 61 of the manifold plate 55, which creates a heat flux path 62. This source of heat loss makes it difficult to control the temperature of the nozzle 40 at the skirt end 42. To solve this problem, the heating assembly 10 has more coil groups 20 in the base zone 32 so as to generate a greater magnetic flux (and thus a higher eddy current and inductive heating) in this rear skirt area of the nozzle, compensating for the thermal losses.

Similarly, at the tip end of the nozzle, illustrated in FIG. 3b, there is a similar heat flux path 66, in this case a hot/cold interface 65 between the heated nozzle tip retainer 46 which abuts the relatively cooler gate insert 53. Again, the thermal losses here are compensated for by providing a relatively greater number of coil turns (groups 20) in the tip zone 34 of the nozzle 40.

FIG. 4 shows in greater detail a cross-sectional view of the nozzle tip area (tip zone 34). The heat flux path 66 straddles the hot/cold contact interface 65 between the heated nozzle tip retainer 46 and relatively cooler gate insert 53. Multiple coil groups 20 are provided in the tip zone 34 to compensate for this source of thermal losses, and provide a more uniform nozzle temperature along the nozzle length. The outer flux concentrator body 27 maintains a relatively greater portion of the magnetic flux in the nozzle 40, thus reducing inductive heating of the outer gate insert 53 (also of ferromagnetic steel). An air gap 37 is provided between the flux concentrator body 27 and inner surface of the bore in gate insert 53 which provides one or more of: a) easier insertion of the nozzle/heater assembly 40/10 into the bore of the manifold plate 55 and gate insert 53; b) reduced thermal conduction from the nozzle 40 to the manifold plate 55 and gate insert 53; and c) elimination of the need for tight clearances between the manifold plate (or gate insert) and the heater assembly 10.

FIG. 5 illustrates one benefit of the present embodiment, namely more efficient use of energy in this nozzle heating environment. FIG. 5 is a graph of temperature on the vertical axis and radial position 9 (see FIG. 4) along the horizontal axis, showing a radial temperature profile 69 for the inductive heating assembly 10 in this environment. On the vertical axis, the relatively highest temperature 70 is the processing temperature desired for the polymer melt in channel 47 of the nozzle 40. Intermediate temperature 71 is a temperature of the inductive heating assembly 10. Lowermost temperature 72 is the mold temperature (e.g. the gate insert 53). Moving along the horizontal axis, from left to right, there is delineated by dashed lines a melt channel area 47′, followed by a nozzle housing wall 41′, each at approximately the processing temperature 70. Then, there is a substantial temperature drop in the inner air gap 36′, down to approximately the temperature 71 of the inductive heater 10′. Then, there is a second significant temperature drop across the outer air gap 37′ between the heater assembly 10 and mold 53 (the latter being at the lowermost mold temperature 72).

FIGS. 6-7 illustrate a comparative (hypothetical) resistive heater 80 of similar configuration and dimensions as the inductive heating assembly 10 of FIGS. 1-4. FIG. 6 shows a cross-sectional view of this comparative resistive heater at the tip end (similar to FIG. 4). Compared to FIG. 6, the resistive heater 80 has a resistive heating element 81 wrapped around the outer surface of the nozzle retainer 46; the resistive heating element 81 is shown as a coil of tightly packed turns forming a group at the tip end similar to the coil group used in the invention of assembly 10 (FIG. 4). A sheath 82 of dielectric material is disposed over the resistive coil 81. A substantially larger air gap 84 is provided between the sheath 82 and inner surface of the bore in the gate insert 53, in order to reduce heat conduction (thermal losses) from the resistive heater to the cool outer mold assembly.

FIG. 7 illustrates the radial temperature profile 86 of this comparative resistive heater 80, in a manner similar to FIG. 5. However, there are significant differences in the temperature profile. In FIG. 7, the resistive heater temperature 87 must be above the melt processing temperature 88 so that there is thermal conduction of heat from the resistive element 81 to the nozzle 40. As a result, there is a significantly greater temperature drop between the resistive heater (at temperature 87) and the mold (e.g. gate insert 53 at mold temperature 89), compared to the much lesser temperature drop shown in FIG. 5 between the inductive heater at temperature 71 and mold at temperature 72. The lesser temperature drop between the inductive heating assembly 10 and mold 53 in FIG. 5 represents a more efficient utilization of energy supplied to the heating assembly 10, compared to the resistive heater 80. As shown in FIG. 5, the inductive heating assembly 10 is preferable because the highest temperature is that of the melt in the nozzle channel, as desired, and the temperature gradient from the melt to the cooler manifold plate 55 and gate insert 53 is reduced (compared to the resistive heater 80). This represents a substantial energy savings. It also enables the use of smaller bores in the manifold plate 55 and gate insert 53—a more compact design enabling higher cavitation and/or a smaller injection molding machine.

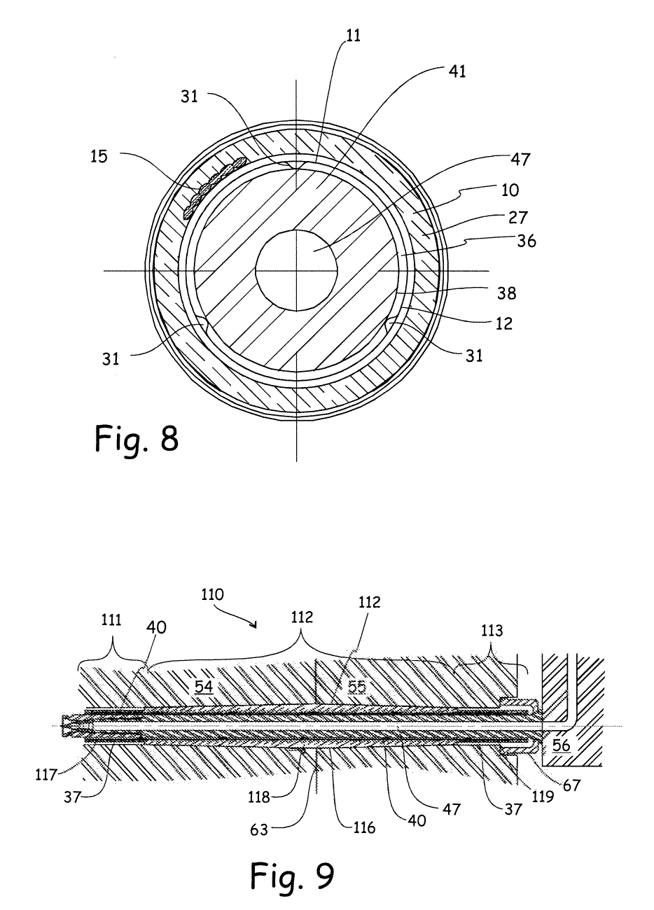

FIG. 8 is a radial cross-sectional view of an alternative embodiment with one or a plurality of axial standoffs 31 for maintaining a constant distance (air gap) between the outer surface of the nozzle 40 and the inner surface of the inductive heating assembly 10. The axial standoffs 31 are shown distributed around the circumference of the air gap 36, between the nozzle outer surface 38 and heater assembly inner surface 12. As previously described, providing an air gap between the nozzle and heating assembly is useful in reducing thermal conduction from the heated nozzle to the (relatively cooler) heating assembly 10.

FIG. 9 is an axial cross-sectional view of an alternative inductive heating assembly 110. In this embodiment, a central section of the heater assembly 110 is in contact with the surrounding mold components (e.g. cavity plate 54 and manifold plate 55) so that shear heat generated by flow of the plastic melt through the nozzle channel 47 can be more readily transferred to the surrounding (relatively cooler) mold components. Production of excessive shear heat is more likely to occur in very long and thin nozzles (having a very high aspect ratio of 15 or greater). This excessive shear heat can be a problem in the central section of the heater assembly, where there are lower thermal losses. In contrast, at the tip section 111 and rear section 113 where a relatively high heat flux path already exists (as previously described) an air gap 37 provided between the outer surface of the outer body 116 (flux concentrator) and surrounding mold component (cavity plate 54 or manifold plate 55) can effectively dissipate the shear heat. In the embodiment of FIG. 9, the radial thickness of the heater assembly 110 in the center section 118 is greater than that of the tip section 117 and rear section 119, thus enabling contact (with the surrounding mold) in the middle section and an air gap at each end. Axial standoffs 31 such as those shown in FIG. 8 may be provided in the air gap 37 between the tip section 117 and/or rear section 119 and outer mold components as desired.

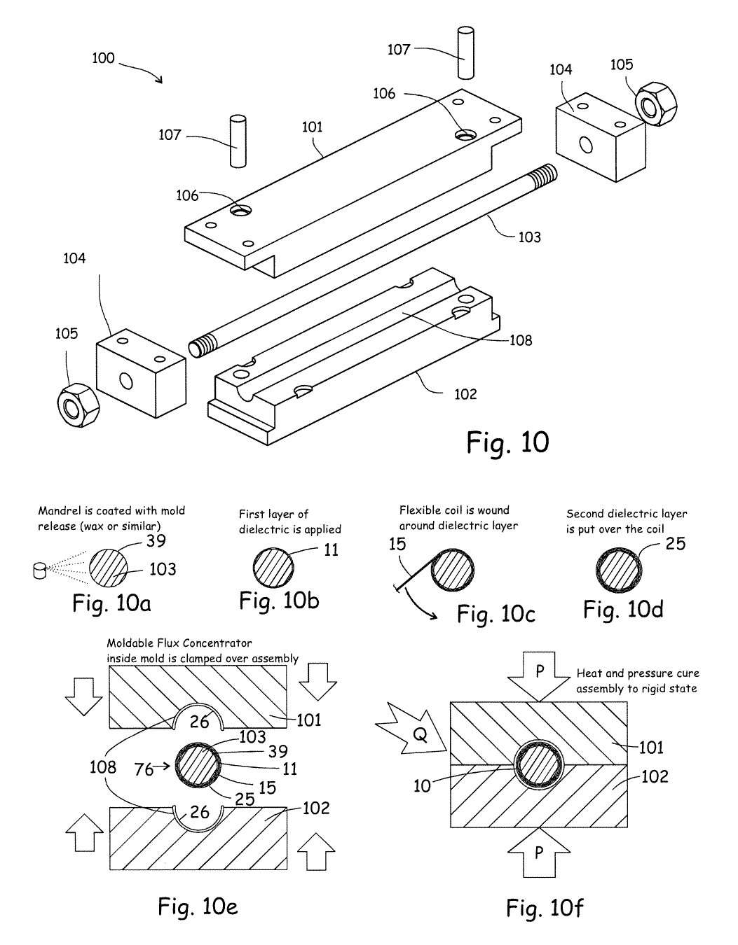

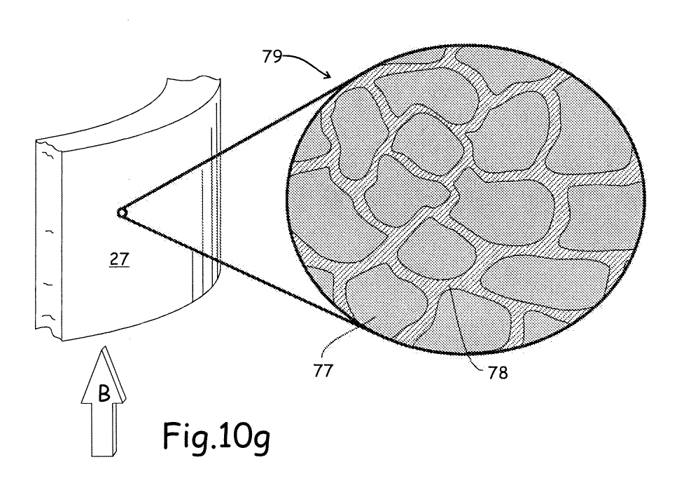

FIG. 10 illustrates one embodiment of an apparatus 100 for manufacturing the composite inductive heating assembly 10 previously described. The apparatus essentially comprises a compression molding assembly. FIG. 10 shows a four (4) part mold, with two (2) elongated complimentary top and bottom mold halves 101, 102 forming an elongated cylindrical channel 108 therebetween, and two (2) opposing mold ends 104, 104 for closing the opposite ends of the mold. A core or mandrel 103 is positionable in the central channel 108, supported at each end by the mold ends. Alignment dowels 107 are positioned in alignment bushings 106 provided in the top and bottom mold halves 101, 102 for aligning the mold halves. Axial compression nuts 105, 105 are provided at each end for attaching the mold ends 104, 104 to opposite ends of the mandrel 103.

According to one manufacturing embodiment, a dielectric layer 11 is provided over the mandrel (FIG. 10b). Optionally, a wax layer 39 may initially be applied over the mandrel (FIG. 10a), which layer 39 can be melted by heating so that the composite heating assembly 10 will more easily slide off the mandrel 103. An inductive coil 15 is then provided over (e.g. wound around) the dielectric layer 11 (FIG. 10c). Another dielectric layer 25 may be applied over the coil 15 and inner dielectric layer 11 (FIG. 10d). The return coil leads may then be positioned over the outer dielectric layer 25. One or more portions 26 of moldable flux concentrator material are then laid down in the central channel 108, in each of the top and bottom mold halves 101, 102 (FIG. 10e). The preassembled mandrel 30 with surrounding layers (wax layer 39, inner dielectric layer 11, coil 15 and outer dielectric layer 25), is then placed on the moldable flux concentrator material in the channel and the mold halves 101, 102 are joined together, whereby the moldable material is compressed together joining the coil and dielectric layers to form a body. Typically, both heat Q and pressure P would be applied. Once the moldable flux concentrator material has become sufficiently rigid (e.g. cured) as to be self-supporting, the mold halves are separated, the mold ends are removed, and the composite assembly 10 is removed from the mandrel.

The previously described apparatus and method enables production of an integrated heating assembly 10 of compact design. This becomes apparent by considering the relative dimensions of the examples shown in FIGS. 4 and 5, namely the inductive heating assembly 10 according to one embodiment of the present invention (shown in FIG. 4) versus the comparative (hypothetical) resistive heater 80 (shown in FIG. 6). The relative dimensions are set forth below:

| Component | FIG. 4 | FIG. 5 | |
|---|---|---|---|
| Nozzle OD | 12.7 mm | 12.7 | mm |
| Inner Air Gap OD | 13.7 mm | 0 | |
| Assembly OD | 17.1 mm | 18.7 | mm |
| Outside Air Gap OD | 18.0 mm | 23.0 | mm |

As set forth above, the overall nozzle/heater outside dimension for the resistive heater 80, namely 23 mm, is much greater than that for the inductive assembly 10, namely 18 mm. Again, the more compact composite inductive assembly enables use of smaller bores in the mold assembly, which enables higher cavitation and/or a smaller injection molding machine.

The following are representive layer thickness for the various components of the inductive assembly 10 of FIG. 4:

| Component | Thickness |
|---|---|
| Inner Dielectric 11 | 0.1 mm |
| Coil 15 | 0.3 mm |
| Outer Dielectric 25 | 0.1 mm |
| Flux Concentrator Body 27 | 1.2 mm |
| Overall Assembly 10 | 1.7 mm |

FIG. 10g is a magnified view of the material composition of the flux concentrator body 27 of the present embodiment. The material includes flux concentrator particles or grains 77 which are surrounded and held together by an electrically insulative thermoset polymer 78. Prior to molding, the flux concentrator material may comprise particulate matter (like grains of sand) comprising electrically conductive and/or ferromagnetic grains 77 coated with a layer of the thermoset polymer 78; this particulate material may be poured into the central channel 108 of the mold assembly 101/102 of FIG. 10. Upon the application of heat and pressure, the powdery or particulate material becomes condensed to form a rigidified molded body that is self-supporting, and which supports the other non-self-supporting layers of the assembly (i.e. the inner dielectric layer 11, coil 15, and optional outer dielectric 25).

Generally, the flux concentrator material may comprise grains of an electrically conductive and ferromagnetic material such as iron, cobalt or nickel, including alloys and oxides thereof. The electrically insulative polymer may be a thermoset polymer, selected to withstand the operating temperature of the inductive heating assembly 10, while providing structural support to the entire assembly. In one example, the flux concentrator material may be AlphaForm flux concentrator material available from Alpha 1, 1525 Old Alum Creek Drive, Columbus, Ohio, USA. AlphaForm is 8-15% polymers of epichlorohydrin, phenol-formaldehyde, and 85-92% iron particles.

For a given application, a manufacturer may select the thinnest possible flux concentrator body which provides a sufficient mechanical integrity to the assembly, and that contains substantially all of the magnetic flux without saturation of the flux concentrator (e.g. prevents the magnetic flux from extending into the outer electronically conductive and/or ferromagnetic mold assembly 50). In selecting the material thickness, the parameters to be considered are the frequency of operation and the magnetic flux density.

For example, in a low power consumption application it is unlikely that the flux concentrator would become saturated. In this case, the minimum thickness would be determined by the need for mechanical integrity of the assembly and the manufacturing process.

In contrast, for a higher power application, such as heating a sprue bushing or a tube heater, the thickness of the flux concentrator must be sufficiently large to prevent saturation of the flux concentrator. The necessary thickness may thus be greater than the thickness required simply for mechanical integrity.

The embodiment of FIGS. 1-4 is a significant improvement over prior known inductive and resistive heating designs in terms of its ability to deliver a high power density in at least select areas of the heater assembly, while providing a compact design. It enables use of litz wire coil which is relatively thin and flexible (i.e. not self-supporting) and not requiring active cooling. The radial thickness of the heater can be relatively thin (e.g. 1.5 to 2 mm), compared to the diameter of the article being heated. The previously described overall heater assembly thickness of 1.7 mm is quite low, considering the relatively high aspect ratio of the nozzle being heated. In the disclosed example (FIG. 4), not intended to be limiting, the injection molding nozzle has 12.7 mm outside diameter and a length of about 100 mm. The inner air gap is about 0.5 mm in thickness, and the outer air gap about 0.5 mm in thickness. Again, this is a very compact heater design for an application requiring relatively high power density, at least along some portions of the nozzle.

In the alternative embodiment of FIG. 9, achieving uniform heating of an even higher aspect ratio nozzle (e.g. axial length to outer diameter ratio of at least 15) is problematic because the excessive shear heat generated in the central portion of the elongated nozzle has a relatively long path to travel to reach the ends of the nozzle where thermal losses are generally greater. For example, this nozzle may have a one-quarter inch outer diameter and a length of 180 mm. For this reason, in FIG. 9 the central section of the heater assembly is placed in contact with the outer mold assembly to dissipate shear heat. Optionally, the central section may also be in contact with the nozzle (for the same purpose). In contrast, at each end where there is already greater thermal conduction, an air gap is allowable (it will allow sufficient heat transfer to prevent overheating of the nozzle ends). In this embodiment, the contact area between the nozzle and outer cold mold assembly is limited to where it is needed for dissipation of excessive shear heat, without otherwise wasting the energy supplied to the inductive heating coil (i.e. there is no contact (an air gap) to the cold outer mold assembly where dissipation of shear heat is not required). In this embodiment, in order to bring the center section of the nozzle up to the desired operating temperature, it would be useful during startup to provide a relatively greater heating rate in the central contact region versus the end regions of the nozzle.

Litz wire is a special type of wire used in electronics and is designed to reduce the skin effect and proximity effect losses in conductors. It consists of many thin wires, individually coated with an insulating film which are twisted and woven together in a desired pattern, often involving several layers. See www.Wikipedia.org, Litz Wire.

In one example, litz wire having 3 to 25 strands of a size of 20-40 AWG may be useful. As another example, litz wire having 5 strands of 30 AWG may be useful, particularly for smaller diameter nozzles (outer diameter of 3 to 13 mm). For low temperature applications (e.g. polymer injection molding), the litz wire may be insulated with polyimide and have a copper conductor. In very low power density applications, a solid core conductor may be used instead of litz wire. In low current applications, litz wire may be used having a maximum rating of 10 RMS.

In various embodiments, the aspect ratio (axial length to outer diameter) of the composite heater assembly is at least 1:1, and more preferably in the range of 2-30. As previously described, a high aspect ratio would be 15 or greater.

Other alternative moldable flux concentrator materials are available from: Fluxtrol Inc., 1388 Atlantic Boulevard, Auburn Hills, Mich. Fluxtrol is an engineering material comprised of ferromagnetic particles (iron) individually electrically insulated from each other by a thermoset polymer. Fluxtrol perpetuates a magnetic field without heating itself, increasing coupling and efficiency of an induction heating installation. Ferrotron is another material (available from Fluxtrol Inc.) similar to Fluxtrol, with the size of the individual ferromagnetic particles being smaller, and thus the operating frequency range over which it will perpetuate a magnetic field without heating itself, is larger.

As previously described, AlphaForm is a moldable ferromagnetic material that has a bulk permeability conducive to perpetuating a magnetic field without itself being heated. It is electrically non-conductive. Generally, it would be desirable to provide a moldable flux concentrator: 1) having a saturation density of at least 0.6 Tesla and a relative magnetic permeability of at least 5; and 2) having an electrical resistively of at least 100Ωcm.

In an alternative embodiment, it may be desirable to include an additive in the moldable ferromagnetic material, such as a ceramic to increase the operating temperature.

Generally, the flux concentrator may include a ferromagnetic additive such as iron, cobalt, and/or nickel, and alloys and oxides thereof. Alternatively, the additive may be electrically conductive but not ferromagnetic.

The following optional and alternative material choices may be useful in one or more embodiments of the present invention:
for the dielectric layers: Kapton; polyimide; mica; ceramic; Teflon; fiberglass; carbon fiber composite;
for the coil: a high temperature litz wire made of, for example, polyimide, Teflon, Kapton or ceramic layer; other litz wire conductive materials include: copper, silver, nickel, gold, platinum and carbon nanotubes;

Kapton is a polyimide available from DuPont (Del. USA); it is a high temperature polymer (e.g. operating temperature of up to 400° C.).

The thickness of the dielectric layer, in various embodiments, may be between 0.004 and 0.05 inch; as one example, a Kapton dielectric layer is provided having a thickness in the range of 0.004 inch to 0.01 inch.

The air gap between the outer diameter of the heating assembly and the bore of the mold may be, in select embodiments, from 0 to 12 mm, and in further select embodiments, from 0.25 to 1 mm.

The air gap between the nozzle body and inner diameter inductive heating assembly, in various embodiments, can range from 0 to 3 mm, and in select embodiments from 0.7 to 1.5 mm.

Although a particular embodiment of the invention (a nozzle heater) has been described, the inductive heating assembly of the present invention is not limited to the described embodiment. Other suitable applications include: sprue heaters, manifold heaters, tube heaters, small laboratory furnaces (e.g. for driving off volatiles), pipe heaters, fuel line heaters, medical device heaters and various heating equipment in the fields of injection molding, die casting, soldering, brazing, compression molding, food processing, and water treatment.

The heater assembly is not limited to specific materials, shapes or configurations of the components thereof. A particular application or environment will determine which materials, shapes and configurations are suitable.

For example, the coil may be one or more of nickel, silver, copper and nickel/copper alloys. A nickel (or high percentage alloy) coil is suitable for higher temperature applications (e.g. 500 to 1000° C.). A copper (or high percentage copper alloy) coil may be sufficient for low temperature applications (e.g. less than 500° C.). The coil may be stainless steel or Inconel (nickel alloy). The dielectric insulation may be a powder, sheet, or cast body surrounding the coil. It maybe a ceramic such as one or more magnesium oxide, alumina, and mica. The inner dielectric layer need not be continuous, e.g. discontinuous dielectric spacer elements providing an air gap between the nozzle and heater assembly.

The coil geometry may take any of various configurations, such as serpentine or helical. The coil configuration may be cylindrical, flat or contoured. The coil may be wound around the article being heated, or disposed along one or more surfaces of the article to be heated. The coil cross section may be flat, round, rectangular or half round. As used herein, coil is not limited to a particular geometry or configuration; a helical wound coil of flat cross section is only one example.

In various applications the various components of the inductive heating method and apparatus may have the following properties:
the coil is electrically conductive, can withstand a designated operating temperature, and is paramagnetic at the operating temperature;
the article to be heated (e.g. steel nozzle) is electrically conductive and preferably ferromagnetic at the desired operating temperature, is thermally conductive, and has a relatively uninterrupted path for the eddy current to flow;
the dielectric material is electrically insulative, preferably thermally non-conductive, and substantially completely paramagnetic;
the flux concentrator does not exceed its Curie point during operation, has a high magnetic permeability, can withstand the desired operating temperatures, and has an interrupted (restricted) circumferential path for the eddy current to flow (and optionally is non-conductive).

In those applications which require indirect heating of an adjacent article or material (e.g. a material in a channel or bore of an inductively heated article), the article/material to be indirectly heated will also affect the parameters of the assembly components, the applied signal and heating rates. In various embodiments, the material to be heated may include one or more of a metal and a polymer, e.g. a pure metal, a metal alloy, a metal/polymer mixture, etc. Still further, the adjacent article or material may itself be electrically conductive and/or ferromagnetic, and thus inductively heated (directly).

A good power transfer (high inductive heating efficiency) can be achieved when groups of coil turns are intermittently disposed along the length of the heating assembly, as opposed to having a constant coil pitch along the length of the assembly. These groups of coils act as individual conductors in series.

Alternatively, multiple sets of coil groups may be used, the groups within each set being powered in series, but the separate sets being powered in parallel.

The number of coil turns in each group, which may be the same or different, determines the equivalent eddy current resistance for the adjacent article being heated. Providing a greater number of turns per unit length is desirable in areas where there are losses, in order to achieve a more uniform temperature distribution along the entire article. Multiple layers of coils (and thus more turns) may also be provided in groups where there are high thermal losses. Thus, the total power input to the article must account for both the thermal losses and the energy to be added to the article to heat or maintain the article at the desired temperature.

In general, providing discrete groups of coil is particularly beneficial in applications with a high aspect ratio (long and thin) article. For example, the use of coil groups is particularly beneficial where the aspect ratio of the article length to the article outer diameter is at least 5:1, more preferably at least 10:1, and still more preferably 15:1. The coil and article length may form a load having a damping coefficient in a range of 0.1 to 0.9.

The coil turns within a group are preferably closely adjacent to one another in order to reduce the leakage field. Preferably, the coil turns are as close together as possible, as allowed by the electrical insulation between the coils. The insulation must provide a dielectric strength equal to the voltage between adjacent turns. Preferably, the insulated coil turns are in direct contact. In other alternatives, the turns have a pitch of one, one-half, or at most 2 coil diameters apart.

In various environments, the coil groups may be substantially evenly spaced along the article length. The coil groups may have the same number of turns per group. The coil groups may be unevenly spaced along the article length. Multiple layers of one or more coils may be provided along at least a portion of the article length intensifying the magnetic flux. These multiple layers may be provided adjacent at least one end of the article. The coil may have a relatively greater number of turns adjacent to at least one end of the article length.

In various applications, it may be desirable to supply a signal to the coil comprising current pulses having a desired amount of pulse energy in high frequency harmonics for inductive heating of the article, as described in Kagan U.S. Pat. Nos. 7,034,263 and 7,034,264, and in Kagan U.S. Patent Application Publication No. 2006/0076338 A1, published Apr. 13, 2006 (U.S. Ser. No. 11/264,780, entitled Method and Apparatus for Providing Harmonic Inductive Power). The current pulses are generally characterized as discrete narrow width pulses, separated by relatively long delays, wherein the pulses contain one or more steeply varying portions (large first derivatives) which provide harmonics of a fundamental (or root) frequency of the current in the coil. Preferably, each pulse comprises as least one steeply varying portion for delivering at least 50% of the pulse energy in the load circuit in high frequency harmonics. For example, the at least one steeply varying portion may have a maximum rate of change of at least five times greater than the maximum rate of change of a sinusoidal signal of the same fundamental frequency and RMS current amplitude. More preferably, each current pulse contains at least two complete oscillation cycles before damping to a level below 10% of an amplitude of a maximum peak in the current pulse. A power supply control apparatus is described in the referenced patents/application which includes a switching device that controls a charging circuit to deliver current pulses in the load circuit so that at least 50% (and more preferably at least 90%) of the energy stored in the charging circuit is delivered to the load circuit. Such current pulses can be used to enhance the rate, intensity and/or power of inductive heating delivered by a heating element and/or enhance the lifetime or reduce the cost in complexity of an inductive heating system. They are particularly useful in driving a relatively highly damped load, e.g., having a damping ratio in the range of 0.01 to 0.2, and more specifically in the range of 0.05 to 0.1, where the damping ratio, denoted by the Greek letter zeta, can be determined by measuring the amplitude of two consecutive current peaks a₁, a₂ in the following equation:

$$ζ = \frac{- ln ( \frac{{a}_{2}}{{a}_{1}} )}{2 π}$$

This damping ratio, which alternatively can be determined by measuring the amplitudes of two consecutive voltage peaks, can be used to select a desired current signal function for a particular load. The subject matter of the referenced Kagan patents/application are hereby incorporated by reference in their entirety.

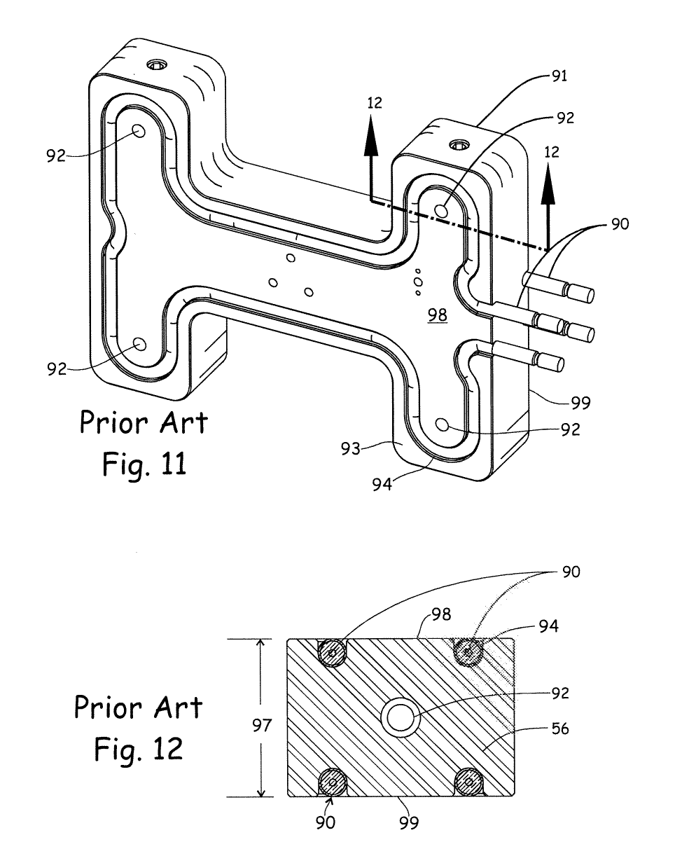

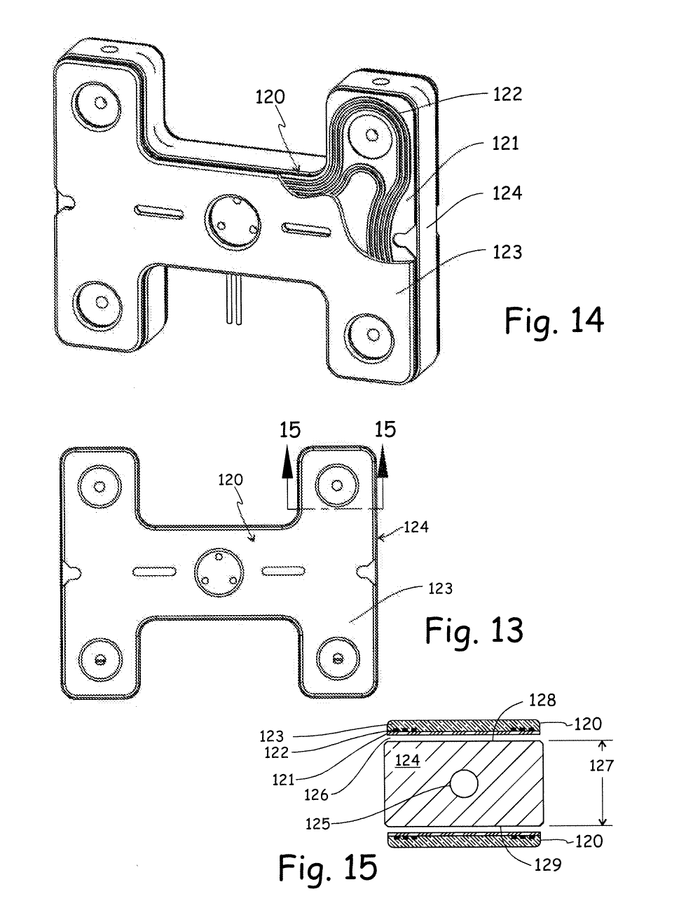

A further embodiment of the invention will now be described with respect to FIGS. 11-15. FIGS. 11-12 illustrate a prior art resistive heater for heating a manifold. FIGS. 13-15 show an embodiment of the present invention for heating a manifold.

FIGS. 11-12 show a prior art arrangement in which a manifold 91 (same/similar to manifold 56 of FIG. 3) includes a plurality of melt channels 92 for feeding plastic melt to multiple respective nozzles. The manifold is a substantially rectangular shaped body having front and rear surfaces 98,99, each of which may include a groove 94 in which a resistive electric heater 90 is disposed for heating of the manifold 91, and thus effectively heating the material flowing through the melt channels 92. The sectional view of FIG. 12 shows one melt channel 92 surrounded by four (4) resistive heaters 90, two (2) disposed on each of the opposing faces of the manifold 91. The manifold thickness 97 is shown as the distance between these opposing planar faces 98, 99 having the grooves/heaters 94/90.

In contrast, in accordance with another embodiment of the present invention, FIG. 13 shows a similarly shaped manifold 124 but, as later described, having a reduced manifold thickness 127 (see FIG. 15). In this embodiment, shown more clearly in the partial cut-away section of FIG. 14, on each of the opposing surfaces of the manifold there is provided a “planar” inductive heating assembly 120 having a substantially flat (planar) configuration (as opposed to the cylindrical configuration of the prior embodiment of FIGS. 1-4). In this embodiment an inner dielectric layer 121 is spaced apart by an air gap 126 from each of the opposing faces 128, 129 of the manifold 124. A coil 122 is disposed over the dielectric layer 121, and a body of flux concentrator material 123 joins the coil and inner dielectric layer to form a composite assembly 120. Because no grooves are required to be cut into the opposing faces of the manifold, the manifold thickness 127 can be effectively reduced (compared to the prior art manifold with resistive heater of FIGS. 11-12). This is beneficial in reducing the cost of the manifold, including eliminating the cost of providing (e.g. machining) the grooves, and in particular may provide a more compact design which enables higher cavitation (more molds in a given injection mold). Still further, one or more benefits of the prior embodiment may also be provided, such as variable or higher power density, tighter temperature control, reduced power consumption, longer operating life, and lower manufacturing costs. To manufacture the planar embodiment of FIGS. 13-15, a modified compression molding apparatus, similar to that shown in FIG. 10, but having a relatively flat and rectangular channel and no mandrel, may be provided. The planar inductive heater embodiment of the present invention is meant to include contoured surfaces which are not strictly flat.

These and other modifications will be readily apparent to the skilled person as included within the scope of the following claims.

1. A composite inductive heating assembly comprising:
an inner layer of dielectric material;
a multi-turn conductive heater coil disposed over the inner layer;
an outer self-supporting body of moldable flux concentrator material rendering the inner layer, coil and flux concentrator into a self-supporting composite assembly.

2. The assembly of claim 1, wherein the assembly is a hollow tubular assembly.

3. The assembly of claim 2, wherein the assembly is positionable over an electrically conductive and/or ferromagnetic article to be inductively heated.

4. The assembly of claim 1, wherein the coil is a thin and flexible low current coil having a maximum rating of 10 amps RMS.

5. The assembly of claim 1, wherein the inner layer is thermally insulative.

6. The assembly of claim 1, wherein the coil has turns of varying pitch.

7. The assembly of claim 1, wherein the coil comprises one or more spaced apart coil groups, each coil group comprising a plurality of more tightly wound coil turns for delivering a higher power density than the areas between the groups.

8. The assembly of claim 1, wherein the outer body is thermally insulative.

9. The assembly of claim 2, wherein the assembly comprises a nozzle heater.

10. The assembly of claim 9, wherein the nozzle heater has an axial length and the coil has varying pitch along the axial length for delivering a higher power density at opposing ends of the heater length.

11. The assembly of claim 1, wherein the coil comprises litz wire.

12. The assembly of claim 1, wherein the flux concentrator material comprises a polymeric material having a ferromagnetic additive.

13. The assembly of claim 1, wherein the flux concentrator material comprises a thermoset polymer and iron oxide particles.

14. The assembly of claim 1, wherein the flux concentrator material is selected from the group consisting of polymer materials capable of maintaining structural integrity at the operating temperature of the flux concentrator body, and includes a ferromagnetic additive.

15. The assembly of claim 13, wherein the ferromagnetic additive is selected from the group consisting of iron, cobalt, and nickel, and alloys and oxides thereof.

16. The assembly of claim 1, wherein the outer body is thermoformed.

17. The assembly of claim 1, wherein the assembly comprises a substantially planar heater assembly.

18. The assembly of claim 1, further comprising a dielectric layer between the coil and outer body to substantially prevent the flux concentrator material from entering the area between the coil turns.

19. The assembly of claim 2, wherein the composite assembly has a radial thickness of from 1.5 to 2 mm.

20. A method of inductively heating an electrically conductive and/or ferromagnetic article comprising:
positioning a composite inductive heating assembly around the article;
the assembly comprising an inner layer of dielectric material adjacent the article, a multi-turn inductive heater coil disposed over the inner body for inducing a magnetic flux in the article, and an outer self-supporting body of moldable flux concentrator material rendering the inner layer, coil and flux concentrator into a self-supporting composite assembly; and supplying a signal to the coil to generate a magnetic flux in the article.

21. The method of claim 20, wherein the dielectric inner layer is thermally insulative and limits thermal conduction of heat from the article to the coil.

22. The method of claim 20, wherein the composite heating assembly is positioned within a bore of an outer electrically conductive and/or ferromagnetic article, and the outer flux concentrator body substantially constrains the magnetic flux to lie within the inner article to be heated so as to limit inductive heating of the outer article.

23. The method of claim 22, wherein the outer article is cooled.

24. The method of claim 23, wherein the flux concentrator material is thermally insulative to limit thermal conduction of heat from the coil to the outer article.

25. The method of claim 20, wherein the article is a tubular nozzle.

26. The assembly of claim 20, wherein an air gap is provided between the article and the inner surface of the composite assembly ranging from 0.25 to 3 millimeters.

27. The assembly of claim 26, wherein the air gap ranges from 0.7 to 1.5 millimeters.

28. The method of claim 22, wherein an air gap is provided between the outer surface of the composite assembly and the bore of the outer article, the air gap being in a range of 0.25 to 1.2 millimeters.

29. The method of claim 28, wherein the air gap ranges from 0.25 to 1 millimeter.

30. The method of claim 22, wherein the assembly has a middle section in contact with the bore and end sections spaced from the bore.

31. The method of claim 22, wherein a signal is supplied to the coil comprising current pulses having a desired amount of pulse energy in high frequency harmonics.

32. A method of making a composite inductive heating assembly comprising:
providing an inner layer of dielectric material;
providing a multi-turn coil over the inner layer;
applying a moldable flux concentrator material over the coil and inner layer and applying pressure to transform the flux concentrator material into a self-supporting substantially non-deformable state, thereby rendering the inner layer, coil and flux concentrator into a self-supporting composite assembly.

33. The method of claim 32, further comprising:
providing a dielectric material over the coil to substantially prevent the flux concentrator material from entering the area between the coil turns.

34. The method of claim 32, wherein the outer body is molded in direct contact with the coil.

35. The method of claim 32, wherein the assembly is formed by disposing the inner layer and coil over a mold core and forming the heating assembly in an outer mold assembly.

36. The method of claim 32, wherein heat and pressure are applied to form the assembly.

37. The method of claim 32, wherein the moldable flux concentrator material is a polymeric material having a ferromagnetic additive.
